(19) United States
(12) Patent Application Publication
(10) Pub. No.: US 2015/0281142 A1
(43) Pub. Date: Oct. 1, 2015

(54) Hot Topic Pushing Method and Apparatus

(71) Applicant: Huawei Technologies Co., Ltd., Shenzhen (CN)

(72) Inventors: Yan Chen, Nanjing (CN); Rui Li, Nanjing (CN)

(21) Appl. No.: 14/669,426

(22) Filed: Mar. 26, 2015

(30) Foreign Application Priority Data
Mar. 28, 2014 (CN) 201410124129.3

(51) Int. Cl. H04L 12/58; H04L 29/08

(52) U.S. Cl. CPC H04L 51/04; H04L 51/16; H04L 67/26

(57) ABSTRACT

A hot topic pushing method and apparatus are provided. The hot topic pushing method includes receiving, by a first user equipment, a hot topic keyword, where the hot topic keyword is related to a second user; and pushing, by the first user equipment, a first message to a first user who uses the first user equipment, where the first message includes the hot topic keyword, or hot information related to the hot topic keyword, or both the hot topic keyword and hot information related to the hot topic keyword, which are available for the first user to select and use as a topic to communicate with the second user.

### CROSS-REFERENCE TO RELATED APPLICATION

This application claims priority to Chinese Patent Application No. 201410124129.3, filed on Mar. 28, 2014, which is hereby incorporated with its entire entity as a reference.

### TECHNICAL FIELD

Embodiments of the present invention relate to network technologies, and in particular, to a hot topic pushing method and apparatus.

### BACKGROUND

With development of communications technologies and network technologies, web chat has become an important means of communication between people, and people maintain interpersonal relationships and bonding by means of web chat. At present, most user equipments (such as a desktop computer, a mobile phone, and a tablet computer) that can be connected to a network provide instant messaging software (such as QQ®, WeChat®, and Skype®) for users to use, so that the users can use the instant messaging software on various user equipments to chat with other users. Chatting manners include multiple manners such as text, speech, video.

However, when the users perform web chat by using the user equipments, a situation often occurs in which both chat users do not have any topic to chat. Although abundant chatting emoticons are added to various types of chatting software to make chatting more interesting, the chat users may still end the chatting because there is no topic to chat.

### SUMMARY

Embodiments of the present invention provide a hot topic pushing method and apparatus, which are used to provide a hot topic for chat users, and improve an effect of web chat on communication between users.

A first aspect provides a hot topic pushing method, including receiving, by a first user equipment, a hot topic keyword, where the hot topic keyword is related to a second user; and pushing, by the first user equipment, a first message to a first user who uses the first user equipment, where the first message includes the hot topic keyword, or hot information related to the hot topic keyword, or both the hot topic keyword and hot information related to the hot topic keyword, which are available for the first user to select and use as a topic to communicate with the second user.

In a first possible implementation manner of the first aspect, the receiving, by a first user equipment, a hot topic keyword includes receiving, by the first user equipment, the hot topic keyword by using a cloud server; or receiving, by the first user equipment, the hot topic keyword sent by a second user equipment that is used by the second user.

With reference to the first aspect or the first possible implementation manner of the first aspect, in a second possible implementation manner, if the first message includes the hot information, before the pushing, by the first user equipment, a first message to a first user who uses the first user equipment, the method further includes obtaining, by the first user equipment, the hot information according to the hot topic keyword, where the hot information includes information whose search volume or browsing volume exceeds a preset threshold, where the information is in a network and is related to the hot topic keyword.

With reference to any one possible implementation manner of the first aspect to the second possible implementation manner of the first aspect, in a third possible implementation manner, before the pushing, by the first user equipment, a first message to a first user who uses the first user equipment, the method further includes obtaining, by the first user equipment, source information of the first message according to the hot topic keyword; and the method further includes pushing, by the first user equipment, the source information of the first message to the first user.

With reference to any one possible implementation manner of the first aspect to the third possible implementation manner of the first aspect, in a fourth possible implementation manner, the pushing, by the first user equipment, a first message to a first user who uses the first user equipment includes generating, by the first user equipment, a hot topic pushing icon in a communication interface between the first user and the second user; and pushing, by the first user equipment, the first message to the first user by using the hot topic pushing icon in the communication interface between the first user and the second user.

With reference to the fourth possible implementation manner of the first aspect, in a fifth possible implementation manner, the pushing, by the first user equipment, the first message to the first user by using the hot topic pushing icon in the communication interface between the first user and the second user includes pushing, by the first user equipment by using the hot topic pushing icon, at least one first message to the first user when the first user clicks or taps the hot topic pushing icon or the first user shakes the first user equipment.

With reference to the fifth possible implementation manner of the first aspect, in a sixth possible implementation manner, the pushing, by the first user equipment by using the hot topic pushing icon, at least one first message to the first user when the first user clicks or taps the hot topic pushing icon or the first user shakes the first user equipment includes, when the first user clicks or taps the hot topic pushing icon or the first user shakes the first user equipment, generating, by the first user equipment, at least one hot topic label, where each hot topic label includes one first message; and presenting, by the first user equipment, the at least one hot topic label to the first user in the communication interface in a preset presenting manner.

With reference to the sixth possible implementation manner of the first aspect, in a seventh possible implementation manner, the presenting, by the first user equipment, the at least one hot topic label to the first user in the communication interface in a preset presenting manner includes, when the first user clicks or taps the hot topic pushing icon and drags and shakes the hot topic pushing icon, presenting, by the first user equipment, the at least one hot topic label to the first user in the communication interface in a manner of dropping from the hot topic pushing icon; or when the first user shakes the first user equipment, presenting, by the first user equipment, the at least one hot topic label to the first user in the communication interface in a manner of dropping from the hot topic pushing icon.

With reference to the seventh possible implementation manner of the first aspect, in an eighth possible implementation manner, a higher speed or a longer time at which or during which the first user drags and shakes the hot topic pushing icon indicates more hot topic labels dropping from the hot topic pushing icon; or a higher speed or a longer time at which or during which the first user shakes the first user equipment indicates more hot topic labels dropping from the hot topic pushing icon.

With reference to any one possible implementation manner of the first aspect to the eighth possible implementation manner of the first aspect, in a ninth possible implementation manner, the hot topic keyword of the second user includes at least one of the following: a keyword in a chat record between the first user and the second user, a keyword in dynamic information published by the second user, and a keyword in a microblog published by the second user.

A second aspect provides a hot topic pushing method, where the method includes acquiring, by a second user equipment, a hot topic keyword of a second user who uses the second user equipment; and sending, by the second user equipment, the hot topic keyword to a first user equipment, so that a first user who uses the first user equipment uses a first message as a topic to communicate with the second user, where the first message includes the hot topic keyword, or hot information related to the hot topic keyword, or both the hot topic keyword and hot information related to the hot topic keyword.

In a first possible implementation manner of the second aspect, the sending, by the second user equipment, the hot topic keyword of the second user to a first user equipment includes sending, by the second user equipment, the hot topic keyword to the first user equipment by using a cloud server; or directly sending, by the second user equipment, the hot topic keyword to the first user equipment.

With reference to the second aspect or the first possible implementation manner of the second aspect, in a second possible implementation manner, the hot topic keyword of the second user includes at least one of the following: a keyword in a chat record between the first user and the second user, a keyword in dynamic information published by the second user, and a keyword in a microblog published by the second user.

With reference to the second possible implementation manner of the second aspect, in a third possible implementation manner, the acquiring, by a second user equipment, a hot topic keyword of a second user who uses the second user equipment includes analyzing, by the second user equipment, at least one of the following: the chat record between the first user and the second user, the keyword in the dynamic information published by the second user, and the keyword in the microblog published by the second user, so as to acquire the hot topic keyword.

A third aspect provides a hot topic pushing apparatus, disposed on a first user equipment, where the hot topic pushing apparatus includes a receiving module configured to receive a hot topic keyword, where the hot topic keyword is related to a second user; and a pushing module configured to push a first message to a first user who uses the first user equipment, where the first message includes the hot topic keyword, or hot information related to the hot topic keyword, or both the hot topic keyword and hot information related to the hot topic keyword, which are available for the first user to select and use as a topic to communicate with the second user.

In a first possible implementation manner of the third aspect, the receiving module is configured to receive the hot topic keyword by using a cloud server; or receive the hot topic keyword sent by a second user equipment that is used by the second user.

With reference to the third aspect or the first possible implementation manner of the third aspect, in a second possible implementation manner, the hot topic pushing apparatus further includes a processing module configured to, if the first message includes the hot information, before the pushing module pushes the first message to the first user, obtain the hot information according to the hot topic keyword, where the hot information includes information whose search volume or browsing volume exceeds a preset threshold, where the information is in a network and is related to the hot topic keyword.

With reference to any one possible implementation manner of the third aspect to the second possible implementation manner of the third aspect, in a third possible implementation manner, the processing module is further configured to obtain source information of the first message according to the hot topic keyword; and the pushing module is further configured to push the source information of the first message to the first user.

With reference to any one possible implementation manner of the third aspect to the third possible implementation manner of the third aspect, in a fourth possible implementation manner, the hot topic pushing apparatus further includes a generating module configured to generate a hot topic pushing icon in a communication interface between the first user and the second user; where the pushing module is configured to push the first message to the first user by using the hot topic pushing icon in the communication interface between the first user and the second user.

With reference to the fourth possible implementation manner of the third aspect, in a fifth possible implementation manner, the pushing module is configured to, when the first user clicks or taps the hot topic pushing icon or the first user shakes the first user equipment, push at least one first message to the first user by using the hot topic pushing icon.

With reference to the fifth possible implementation manner of the third aspect, in a sixth possible implementation manner, the generating module is further configured to, when the first user clicks or taps the hot topic pushing icon or the first user shakes the first user equipment, generate at least one hot topic label, where each hot topic label includes one first message; and the pushing module is further configured to present the at least one hot topic label to the first user in the communication interface in a preset presenting manner.

With reference to the sixth possible implementation manner of the third aspect, in a seventh possible implementation manner, the pushing module is configured to, when the first user clicks or taps the hot topic pushing icon and drags and shakes the hot topic pushing icon, present the at least one hot topic label to the first user in the communication interface in a manner of dropping from the hot topic pushing icon; or when the first user shakes the first user equipment, present the at least one hot topic label to the first user in the communication interface in a manner of dropping from the hot topic pushing icon.

With reference to the seventh possible implementation manner of the third aspect, in an eighth possible implementation manner, a higher speed or a longer time at which or during which the first user drags and shakes the hot topic pushing icon indicates more hot topic labels dropping from the hot topic pushing icon; or a higher speed or a longer time at which or during which the first user shakes the first user equipment indicates more hot topic labels dropping from the hot topic pushing icon.

With reference to any one possible implementation manner of the third aspect to the eighth possible implementation manner of the third aspect, in a ninth possible implementation manner, the hot topic keyword of the second user includes at least one of the following a keyword in a chat record between the first user and the second user, a keyword in dynamic information published by the second user, and a keyword in a microblog published by the second user.

A fourth aspect provides a hot topic pushing apparatus, disposed on a second user equipment, where the hot topic pushing apparatus includes an acquiring module configured to acquire a hot topic keyword of a second user who uses the second user equipment; and a sending module configured to send the hot topic keyword to a first user equipment, so that a first user who uses the first user equipment uses a first message as a topic to communicate with the second user, where the first message includes the hot topic keyword, or hot information related to the hot topic keyword, or both the hot topic keyword and hot information related to the hot topic keyword.

In a first possible implementation manner of the fourth aspect, the sending module is configured to send the hot topic keyword to the first user equipment by using a cloud server; or directly send the hot topic keyword to the first user equipment.

With reference to the fourth aspect or the first possible implementation manner of the fourth aspect, in a second possible implementation manner, the hot topic keyword of the second user includes at least one of the following: a keyword in a chat record between the first user and the second user, a keyword in dynamic information published by the second user, and a keyword in a microblog published by the second user.

With reference to the second possible implementation manner of the fourth aspect, in a third possible implementation manner, the acquiring module is configured to analyze at least one of the following: the chat record between the first user and the second user, the keyword in the dynamic information published by the second user, and the keyword in the microblog published by the second user, so as to acquire the hot topic keyword.

According to the hot topic pushing method and apparatus that are provided in the embodiments of the present invention, a first user equipment receives a hot topic keyword related to a second user, and pushes a first message to a first user who uses the first user equipment, where the first message includes the hot topic keyword of the second user and/or hot information related to the hot topic keyword of the second user, so that the first user selects and uses the first message as a topic to communicate with the second user, avoiding a problem that communication is difficult to continue because users during chatting cannot find a hot topic, and adding more fun to web chat.

### BRIEF DESCRIPTION OF DRAWINGS

To describe the technical solutions in the embodiments of the present invention or in the prior art more clearly, the following briefly introduces the accompanying drawings required for describing the embodiments. The accompanying drawings in the following description show some embodiments of the present invention, and persons of ordinary skill in the art may still derive other drawings from these accompanying drawings without creative efforts.

FIG. 1 is a flowchart of Embodiment 1 of a hot topic pushing method according to an embodiment of the present invention;

FIG. 2 is a flowchart of Embodiment 2 of a hot topic pushing method according to an embodiment of the present invention;

FIG. 3 is a flowchart of Embodiment 3 of a hot topic pushing method according to an embodiment of the present invention;

FIG. 4 is a schematic diagram of a user communication interface in a user equipment;

FIG. 5 is a schematic diagram of another user communication interface in a user equipment;

FIG. 6 is a flowchart of Embodiment 4 of a hot topic pushing method according to an embodiment of the present invention;

FIG. 7 is a schematic diagram of Embodiment 5 of a hot topic pushing method according to an embodiment of the present invention;

FIG. 8 is a schematic structural diagram of Embodiment 1 of a hot topic pushing apparatus according to an embodiment of the present invention;

FIG. 9 is a schematic structural diagram of Embodiment 2 of a hot topic pushing apparatus according to an embodiment of the present invention;

FIG. 10 is a schematic structural diagram of Embodiment 3 of a hot topic pushing apparatus according to an embodiment of the present invention; and

FIG. 11 is a schematic structural diagram of Embodiment 4 of a hot topic pushing apparatus according to an embodiment of the present invention.

### DESCRIPTION OF EMBODIMENTS

To make the purposes, technical solutions, and advantages of the embodiments of the present invention clearer, the following clearly and completely describes the technical solutions in the embodiments of the present invention with reference to the accompanying drawings in the embodiments of the present invention. The described embodiments are some but not all of the embodiments of the present invention. All other embodiments obtained by persons of ordinary skill in the art based on the embodiments of the present invention without creative efforts shall fall within the protection scope of the present invention.

A hot topic pushing method provided in the embodiments of the present invention is applicable to any user equipment that can be connected to a network and provide a web chat function, including but not limited to a mobile phone, a desktop computer, or a tablet computer.

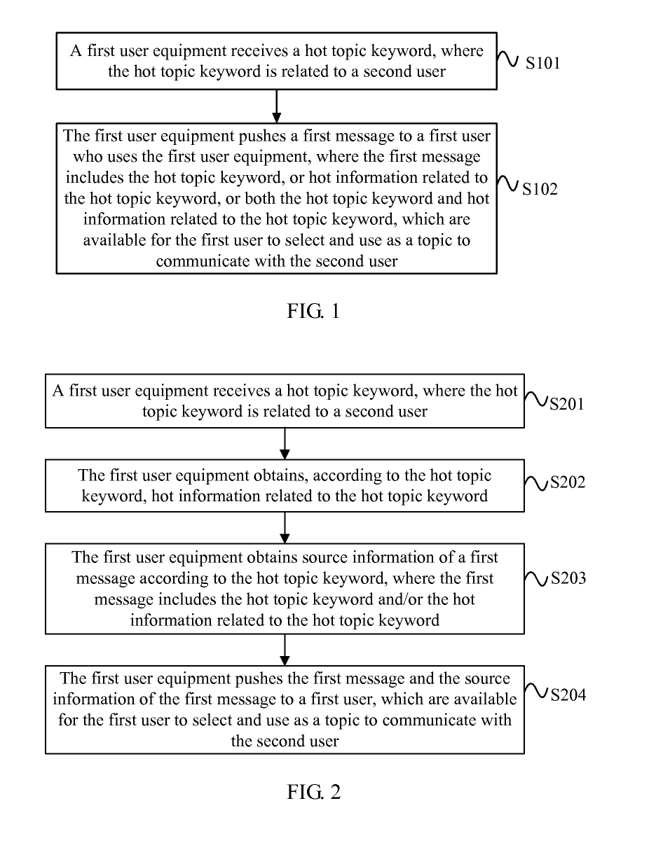

FIG. 1 is a flowchart of Embodiment 1 of a hot topic pushing method according to an embodiment of the present invention. As shown in FIG. 1, the hot topic pushing method in this embodiment includes the following steps.

Step S101: A first user equipment receives a hot topic keyword, where the hot topic keyword is related to a second user.

Web chat is performed between at least two users and each user uses one user equipment. Of the two users who are performing the web chat, a user who first publishes information is referred to as a first user, and a user equipment used by the first user is referred to as a first user equipment; another user who is performing the web chat is referred to as a second user, and a user equipment used by the second user is referred to as a second user equipment.

In a process of web chat between the first user and the second user, the first user needs to first provide a communication topic, so that the first user and the second user continue chatting on the communication topic. If the communication topic provided by the first user is not a topic that interests the second user, the second user is probably not willing to continue chatting on this topic. However, the first user may want to chat with the second user but cannot find a communication topic that interests the second user, or in a process of chatting between the first user and the second user, the first user may end chatting because no new communication topic is found. A purpose of web chat is to provide a communication channel for users. If the users cannot continue chatting or have to end chatting because no communication topic is found, communication between the users is hindered.

Therefore, in this embodiment, the first user equipment first receives the hot topic keyword, where the hot topic keyword is related to the second user. The hot topic keyword includes at least one of the following information: a keyword in a chat record between the first user and the second user, a keyword in dynamic information published by the second user, and a keyword in a microblog published by the second user. That is, the hot topic keyword is extracted from information previously published by the second user, where the information may be directly received by the first user equipment from the second user equipment, and may also be received by the first user equipment by using a cloud server. The hot topic keyword may be acquired from a record locally saved by the second user equipment, and may also be acquired from information published by the second user on the Internet. In a word, the hot topic keyword reflects content that draws the second user's attention or interests the second user.

Step S102: The first user equipment pushes a first message to a first user who uses the first user equipment, where the first message includes the hot topic keyword, or hot information related to the hot topic keyword, or both the hot topic keyword and hot information related to the hot topic keyword, which are available for the first user to select and use as a topic to communicate with the second user.

The hot topic keyword received by the first user equipment reflects content in the information published by the second user, that is, content that draws the second user's attention or interests the second user; therefore the first user equipment may push the hot topic keyword to the first user, so that the first user can learn a hot topic that interests the second user. The first user can communicate well with the second user by using the hot topic that interests the second user as a topic to communicate with the second user to chat with the second user, thereby enhancing bonding between each other and achieving a supposed purpose of the web chat.

In addition, the hot topic keyword received by the first user equipment also reflects only the content in the information published by the second user, and information volume of the content is still small. Therefore, after receiving the hot topic keyword sent by the second user equipment, the first user equipment may further acquire the hot information related to the hot topic keyword. The hot information related to the hot topic keyword includes information whose search volume or browsing volume exceeds a preset threshold, where the information is on the Internet and is related to the hot topic keyword. The hot information related to the hot topic keyword may be acquired from the Internet, for example, searching a search engine for the hot topic keyword and using information with maximum browsing times or a largest search volume as the hot information related to the hot topic keyword; or searching a microblog for the hot topic keyword and using information with maximum forwarding times as the hot information related to the hot topic keyword. After obtaining the hot information related to the hot topic keyword, the first user equipment pushes, to the first user, the hot information related to the hot topic keyword, so that the first user can find a topic to communicate with the second user from the hot information related to the hot topic keyword. Because the hot topic is the hot information related to the information published by the second user, the second user is also interested in the hot topic. Therefore, the first user and the second user can communicate well by means of chatting, thereby enhancing bonding between each other and achieving a due purpose of the web chat. Because the hot information related to the hot topic keyword has a larger information volume than the hot topic keyword, more fun is added to the chatting process.

Further, the first user equipment may simultaneously push, to the first user, both the hot topic keyword and the hot information related to the hot topic keyword, so that more abundant hot topics are available for the first user to select. Therefore, information pushed by the first user equipment to the first user may be referred to as a first message, where the first message includes the hot topic keyword, or the hot information related to the hot topic keyword, or both the hot topic keyword and the hot information related to the hot topic keyword.

In this embodiment, a first user equipment receives a hot topic keyword related to a second user, and pushes a first message to a first user who uses the first user equipment, where the first message includes the hot topic keyword of the second user and/or hot information related to the hot topic keyword of the second user, so that the first user selects and uses the first message as a topic to communicate with the second user, avoiding a problem that communication is difficult to continue because users during chatting cannot find a hot topic, and adding more fun to web chat.

Further, the first user equipment may directly receive the hot topic keyword related to the second user by using a network link between the first user equipment and the second user equipment, and may also receive the hot topic keyword by using a cloud server. The second user equipment may first upload the hot topic keyword to the cloud server, so that the first user equipment can acquire the hot topic keyword from the cloud server, thereby reducing network pressure.

Further, the first message includes the hot topic keyword and/or the hot information related to the hot topic keyword. Therefore, if the first message includes the hot information related to the hot topic keyword, before the first user equipment pushes the first message to the first user who uses the first user equipment, the method further includes obtaining, by the first user equipment, the hot information according to the hot topic keyword, where the hot information includes information whose search volume or browsing volume exceeds a preset threshold, where the information is on the Internet and is related to the hot topic keyword.

FIG. 2 is a flowchart of Embodiment 2 of a hot topic pushing method according to an embodiment of the present invention. As shown in FIG. 2, the hot topic pushing method in this embodiment includes the following steps.

Step S201: A first user equipment receives a hot topic keyword, where the hot topic keyword is related to a second user.

Step S202: The first user equipment obtains, according to the hot topic keyword, hot information related to the hot topic keyword.

Step S203: The first user equipment obtains source information of a first message according to the hot topic keyword, where the first message includes the hot topic keyword and/or the hot information related to the hot topic keyword.

After acquiring the hot topic keyword and the hot information related to the hot topic keyword, the first user equipment may further acquire, by using the Internet, source information of both the hot topic keyword and the hot information related to the hot topic keyword. The hot topic keyword and the hot information related to the hot topic keyword are referred to as the first message, so that acquiring the source information of the first message is acquiring a source location of the first message, for example, acquiring a chat record keyword from a chat record between the first user and the second user, or acquiring a chat record keyword from a microblog published by the second user, or acquiring, from a search engine, hot information related to a chat record keyword of the second user.

Step S204: The first user equipment pushes the first message and the source information of the first message to a first user, which are available for the first user to select and use as a topic to communicate with the second user.

After acquiring the first message and the source information of the first message, the first user equipment pushes the first message and the source information of the first message to the first user. The first user may use the first message to chat with the second user, and the first user can learn a source of the first message by using the source information of the first message, so that the first user can find a related hot topic according to the first message and chatting with the second user. For example, if the first message is a keyword acquired from the microblog published by the second user, the source of the first message is the microblog of the second user; if the first message is the hot information that is related to the hot topic keyword and found by searching the Internet, the source of the first message is a search result on the Internet. The first user can learn, by using the source of the first message, that the second user has different interests in first messages of different sources. Comparing a first message obtained from the microblog of the second user with a first message obtained by searching the Internet, degrees of correlation with the second user are different. The second user pays more attention to the information in the microblog published by the second user than the information obtained by searching the Internet.

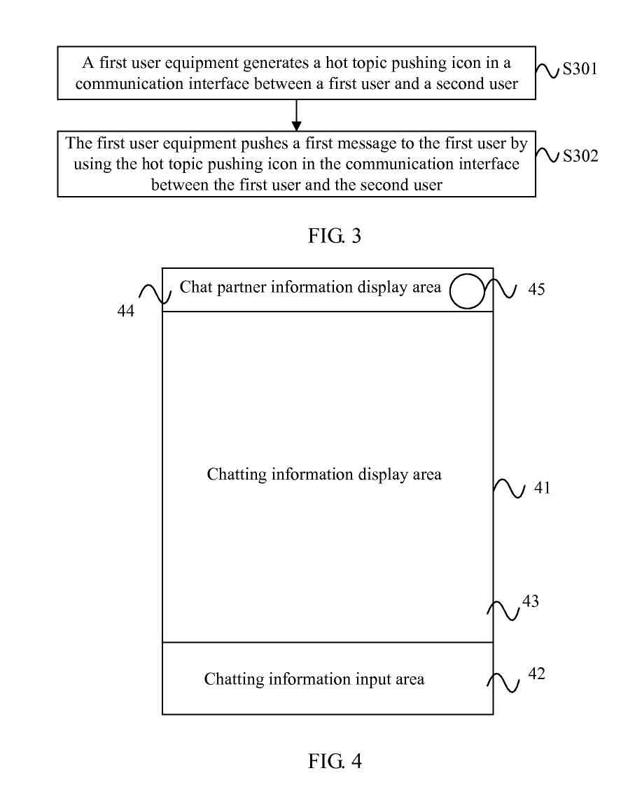

FIG. 3 is a flowchart of Embodiment 3 of a hot topic pushing method according to an embodiment of the present invention. As shown in FIG. 3, the hot topic pushing method in this embodiment includes the following steps.

Step S301: A first user equipment generates a hot topic pushing icon in a communication interface between a first user and a second user.

The hot topic pushing method in this embodiment is a specific method for pushing a first message to the first user by the first user equipment after acquiring the first message. The method in this embodiment may be a specific implementation manner of step S202 in the embodiment shown in FIG. 1, or a specific implementation manner of step S204 in the embodiment shown in FIG. 2.

Users usually use user equipments to perform web chat in a communication interface. In the hot topic pushing method provided in the embodiments shown in FIG. 1 and FIG. 2, it is only described that the first user equipment pushes the first message to the first user, but it is also possible that, in a process of chatting with the second user by using the first user equipment, the first user may personally find a hot topic and does not require the first message pushed by the first user equipment. Therefore, in the method provided in this embodiment, the hot topic pushing icon is generated in the communication interface between the first user and the second user in the first user equipment. The first user equipment sends the first message to the first user only when the first user triggers the hot topic pushing icon.

FIG. 4 is a schematic diagram of a user communication interface in a user equipment. As shown in FIG. 4, a communication interface 41 in the first user equipment includes a chatting information input area 42, a chatting information display area 43, and a chat partner information display area 44. In this embodiment, for example, a hot topic pushing icon 45 may be added to and displayed on the chat partner information display area 44, and the hot topic pushing icon 45 may be presented as an icon in any form.

Step S302: The first user equipment pushes a first message to the first user by using the hot topic pushing icon in the communication interface between the first user and the second user.

The hot topic pushing icon in the communication interface between the first user and the second user may periodically push, to the first user, a first message acquired by the first user equipment, and it may also be that the hot topic pushing icon pushes the first message to the first user only after the first user triggers the hot topic pushing icon.

A manner in which the first user equipment pushes the first message to the first user by using the hot topic pushing icon in the communication interface between the first user and the second user may include, when the first user clicks or taps the hot topic pushing icon or the first user shakes the first user equipment, the first user equipment pushes at least one first message to the first user by using the hot topic pushing icon.

Because the first user equipment that is used by the first user may be a mobile phone, a computer or another user equipment, a manner in which the first user triggers the hot topic pushing icon may be tapping the hot topic pushing icon by using a touchscreen or clicking the hot topic pushing icon by using a mouse cursor. When the first user equipment is a mobile phone, a tablet computer, or another mobile user equipment, because at present most mobile user equipments have a gravity sensing function, a manner in which the first user triggers the hot topic pushing icon may also be triggering by shaking the first user equipment. In addition, because the first user equipment may acquire multiple first messages, the first user equipment may push at least one first message to the first user by using the hot topic pushing icon.

For example, in the embodiment shown in FIG. 4, the hot topic pushing icon 45 may periodically push at least one first message to the first user in the chat partner information display area 44; or when a user clicks or taps the hot topic pushing icon 45, one or more first messages are pushed to the user in the chat partner information display area 44 or the chatting information display area 43.

Further, to make the hot topic pushing icon more interesting, so that the first user is more willing to use the hot topic pushed by the first user equipment to chat with the second user, a manner in which the hot topic pushing icon is triggered to push the first message to the first user may further be more abundant.

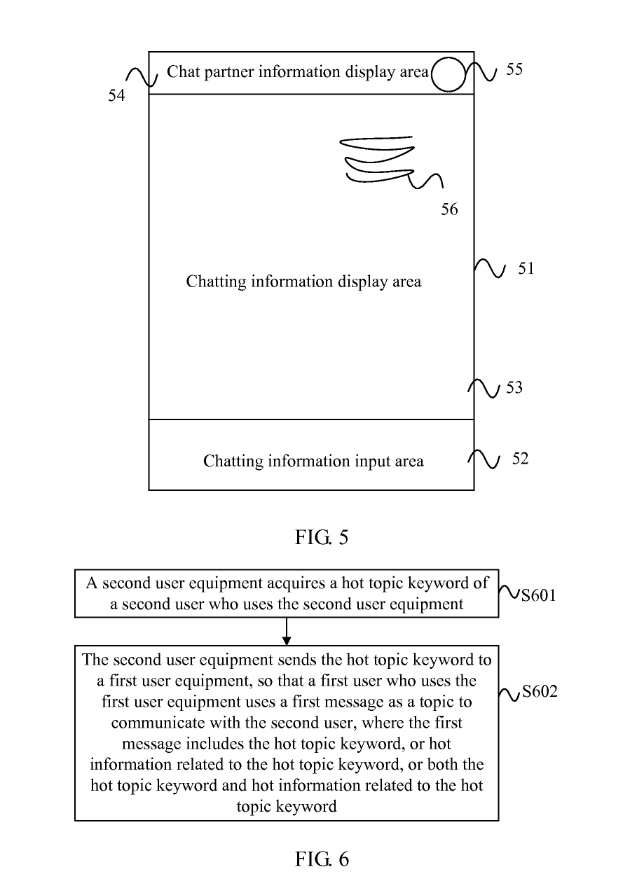

For example, the first user equipment generates at least one hot topic label, where each hot topic label includes one first message. When the first user clicks or taps the hot topic pushing icon and drags and shakes the hot topic pushing icon, the first user equipment presents the at least one hot topic label to the first user in the communication interface in a manner of dropping from the hot topic pushing icon. As shown in FIG. 5, FIG. 5 is a schematic diagram of another user communication interface in a user equipment. A communication interface 51 in the first user equipment includes a chatting information input area 52, a chatting information display area 53, and a chat partner information display area 54. The chat partner information display area 54 includes a hot topic pushing icon 55. When the first user who uses the first user equipment clicks or taps the hot topic pushing icon 55 and drags the hot topic pushing icon 55 to any position in the communication interface 51, and drags and shakes the hot topic pushing icon 55 on a path 56, multiple hot topic labels are displayed in the communication interface 51 in a manner of sequentially dropping from the hot topic pushing icon 55, where each hot topic label includes one first message. The foregoing manner is similar to an operation manner of “sprinkling pepper”, and the longer the time or the higher the speed the first user drags and shakes the hot topic pushing icon 55, the more hot topic labels are displayed in the communication interface 51.

For another example, the first user equipment generates at least one hot topic label, where each hot topic label includes one first message. When the first user shakes the first user equipment, the first user equipment pushes the at least one hot topic label to the first user in the communication interface in a manner of dropping from the hot topic pushing icon. The longer the time or the higher the speed the first user shakes the first user equipment, the more hot topic labels are displayed in the communication interface. In this manner, the first user equipment needs to be a mobile user equipment that has a gravity sensing or motion sensing apparatus. A manner in which the first message is presented from the hot topic pushing icon is similar to that in FIG. 5, and details are not described herein again.

FIG. 6 is a flowchart of Embodiment 4 of a hot topic pushing method according to an embodiment of the present invention. As shown in FIG. 6, the hot topic pushing method in this embodiment includes the following steps.

Step S601: A second user equipment acquires a hot topic keyword of a second user who uses the second user equipment.

The hot topic pushing method provided in this embodiment is an operation executed by a user equipment that is used by a user who subsequently publishes information among two users who perform web chat, where this user is referred to as a second user and the user equipment that is used by this user is referred to as a second user equipment. The other user in the web chat is referred to as a first user, and a user equipment that is used by the first user is referred to as a first user equipment.

In a process of web chat between the first user and the second user, the first user needs to first provide a communication topic, so that the first user and the second user continue chatting on the communication topic. If the communication topic provided by the first user is not a topic that interests the second user, the second user is probably not willing to continue chatting on this topic. When the second user uses the second user equipment, personal information and a historical information record are retained on the second user equipment by means of login or registration or the like. Therefore, the second user equipment may obtain the hot topic keyword of the second user according to the personal information of the second user. The hot topic keyword of the second user includes at least one of the following information: a keyword in a chat record between the first user and the second user, a keyword in dynamic information published by the second user, and a keyword in a microblog published by the second user. That is, the hot topic keyword of the second user is extracted from information previously published by the second user, where the information may be acquired from a record locally saved by the second user equipment, and may also be acquired by the second user equipment from information that is published by the second user on the Internet. In a word, the hot topic keyword of the second user reflects content that draws the second user's attention or interests the second user.

Step S602: The second user equipment sends the hot topic keyword to a first user equipment, so that a first user who uses the first user equipment uses a first message as a topic to communicate with the second user, where the first message includes the hot topic keyword, or hot information related to the hot topic keyword, or both the hot topic keyword and hot information related to the hot topic keyword.

After acquiring the hot topic keyword of the second user, the second user equipment may send the hot topic keyword to the first user equipment by various means. The hot topic keyword of the second user reflects content in the information published by the second user, that is, content that draws the second user's attention or interests the second user. Therefore, the first user equipment may push the hot topic keyword of the second user to the first user, so that the first user can learn a hot topic that interests the second user. The first user can communicate well with the second user by using the hot topic that interests the second user to chat with the second user, thereby enhancing bonding between each other and achieving a due purpose of the web chat.

In addition, the hot topic keyword of the second user also reflects only the content in the information published by the second user, and information volume of the content is still small. Therefore, after receiving the hot topic keyword that is of the second user and is sent by the second user equipment, the first user equipment may further acquire the hot information related to the hot topic keyword of the second user. The hot information related to the hot topic keyword includes information whose search volume or browsing volume exceeds a preset threshold, where the information is on the Internet and is related to the hot topic keyword. The hot information related to the hot topic keyword of the second user may be acquired from the Internet, for example, searching a search engine for the hot topic keyword of the second user and using information with maximum browsing times or a largest search volume as the hot information related to the hot topic keyword of the second user; or searching a microblog for the hot topic keyword of the second user and using information with maximum forwarding times as the hot information related to the hot topic keyword of the second user. After obtaining the hot information related to the hot topic keyword of the second user, the first user equipment pushes, to the first user, the hot information related to the hot topic keyword of the second user, so that the first user can find, from the hot information related to the hot topic keyword of the second user, a topic to communicate with the second user. Because the hot topic is the hot information related to the information published by the second user, the second user is also interested in the hot topic. Therefore, the first user and the second user can communicate well by means of chatting, thereby enhancing bonding between each other and achieving a due purpose of the web chat. Because the hot information related to the hot topic keyword of the second user has a larger information volume than the hot topic keyword of the second user, more fun is added to the chatting process.

In this embodiment, the second user equipment acquires the hot topic keyword of the second user who uses the second user equipment, and sends the hot topic keyword of the second user to the first user equipment, so that the first user who uses the first user equipment selects and uses the first message as the topic to communicate with the second user, where the first message includes the hot topic keyword of the second user and/or hot information related to the hot topic keyword of the second user, avoiding a problem that communication is difficult to continue because users during chatting cannot find a hot topic, and adding more fun to web chat.

Further, the second user equipment may directly send the hot topic keyword of the second user to the first user equipment by using a network link between the second user equipment and the first user equipment, and may also send the hot topic keyword of the second user to the first user equipment by using a cloud server. The second user equipment may first upload the hot topic keyword of the second user to the cloud server, so that the first user equipment can acquire the hot topic keyword of the second user from the cloud server, thereby reducing network pressure.

Further, that a second user equipment acquires a hot topic keyword of a second user who uses the second user equipment includes analyzing, by the second user equipment, at least one of the following: a chat record between the first user and the second user, a keyword in dynamic information published by the second user, and a microblog published by the second user, so as to acquire the hot topic keyword of the second user. That is, according to an analysis of any information published by the second user, the second user equipment may acquire the hot topic keyword of the second user from the information. The method for acquiring a keyword from various types of information by the second user equipment relates to a text processing technology, and the second user equipment may use any existing keyword extracting method, which is not described again in this embodiment of the present invention.

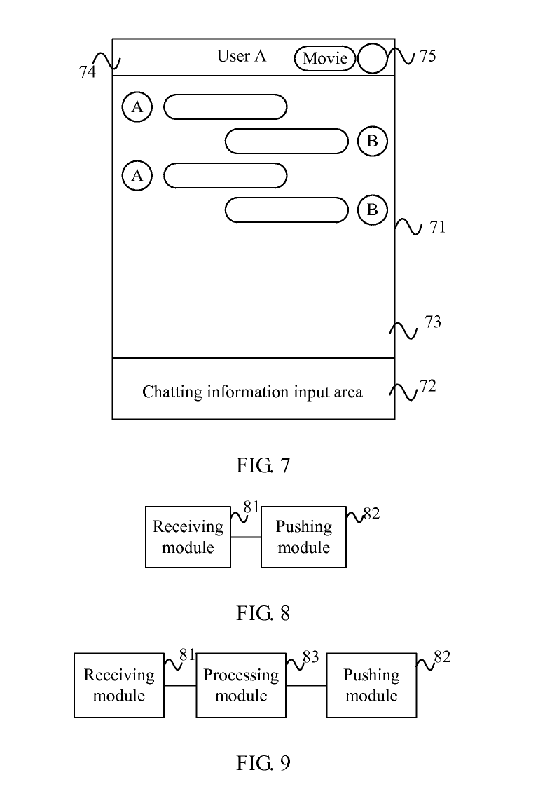

The following uses a specific embodiment to further describe the hot topic pushing method provided in the embodiments of the present invention. FIG. 7 is a schematic diagram of Embodiment 5 of a hot topic pushing method according to an embodiment of the present invention. As shown in FIG. 7, in this embodiment, two users who are performing web chat are respectively a user A and a user B, and the user A uses a user equipment A and the user B uses a user equipment B, where both the user equipment A and the user equipment B are mobile phones. FIG. 7 shows a communication interface 71 of the user equipment B, where the communication interface 71 of the user equipment B includes a chatting information input area 72, a chatting information display area 73, and a chat partner information display area 74. When the user A and the user B are chatting, the chat partner information display area 74 displays information such as a nickname of the user A and a user image picture. Likewise, the user equipment A also has a similar communication interface.

It is assumed that the user A previously used the user equipment A to chat with the user B, and chatted content relates to a movie named “Spider-Man” that was previously watched by the user A. The user A and the user B discussed content of the movie, and the user equipment A stored the foregoing chat record between the user A and the user B. When the user B uses the user equipment B to chat with the user A, the user equipment A acquires a hot topic keyword of the user A from the foregoing stored chat record between the user A and the user B. For example, at least two keywords “movie” and “Spider-Man” can be acquired from the chat record of the movie “Spider-Man” that has been discussed by the user A and the user B. The user equipment A sends the obtained two keywords “movie” and “Spider-Man” to the user equipment B. The chat partner information display area 74 of the user equipment B includes a hot topic pushing icon 75, and the hot topic pushing icon 75 is presented in a “topic cloud” manner. When the user B taps the hot topic pushing icon 75, the keyword “movie” is displayed in the chat partner information display area 74; when the user B taps again the hot topic pushing icon 75, the keyword “Spider-Man” is displayed in the chat partner information display area 74. When the user B taps and drags the hot topic pushing icon 75 to the chatting information display area 73 and shakes the hot topic pushing icon 75, the two keywords “movie” and “Spider-Man” are sequentially displayed in a manner of dropping from the hot topic pushing icon 75. In this way, an operation of pushing, to the user B, a hot topic related to the user A is complete.

It is further assumed that the user A also used the user equipment A to forward a piece of microblog information about “A Bite of China”, then the user equipment A can extract a keyword “food” from the microblog information. The user equipment A sends the obtained three keywords “movie”, “Spider-Man”, and “food” to the user equipment B. The hot topic pushing icon 75 periodically and sequentially (such as at every 30 second intervals) displays the keywords “movie”, “Spider-Man”, and “food” in the chat partner information display area 74. Similarly, when the user B taps and drags the hot topic pushing icon 75 to the chatting information display area 73 and shakes the hot topic pushing icon 75, the three keywords “movie”, “Spider-Man”, and “food” are sequentially displayed in a manner of dropping from the hot topic pushing icon 75. In this way, an operation of pushing, to the user B, a hot topic related to the user A is complete.

For another example, after the user equipment B receives the three keywords “movie”, “Spider-Man”, and “food” that are sent by the user equipment A, the user equipment B can acquire current hot information related to the foregoing keywords from the Internet, for example, obtain a current hit movie “Iron Man 3” according to the keyword “movie”, and obtain a popular local restaurant “XX restaurant” according to the keyword “food”. The hot topic pushing icon 75 periodically and sequentially (such as at every 30 second intervals) displays the keywords “movie”, “Spider-Man”, “food”, “Iron Man 3”, and “XX restaurant” in the chat partner information display area 74. Similarly, when the user B taps and drags the hot topic pushing icon 75 to the chatting information display area 73 and shakes the hot topic pushing icon 75, the five keywords “movie”, “Spider-Man”, “food”, “Iron Man 3”, and “XX restaurant” are sequentially displayed in a manner of dropping from the hot topic pushing icon 75. In this way, an operation of pushing, to the user B, a hot topic related to the user A is complete.

In addition, the user equipment B may further acquire source information of the keyword that is acquired from the user equipment A or from the Internet, for example, source information of the “movie” and “Spider-Man” is a chat record; source information of the “food” is a microblog published by the user A; and source information of the “Iron Man 3” and “XX restaurant” is a search engine. When the user B taps a keyword, a source of the keyword and full text information of the source are displayed under the keyword that is tapped by the user B.

The user B may select, according to the keyword displayed in the chatting information display area 73 or the chat partner information display area 74, a hot topic to chat with the user A.

The foregoing embodiments of the present invention only show a processing and interaction procedure of user equipments that are used by two users who are performing web chat, but the hot topic pushing method provided in the present invention is not limited to a situation in which two users use two user equipments to perform chatting. When more than two users are performing multi-person chatting, a user equipment that is used by each user can receive a hot topic keyword that is sent by a user equipment that is used by another user, and perform processing according to the hot topic pushing method provided in the embodiments of the present invention, whose principle and specific implementation process are similar to those in the foregoing embodiments and details are not described herein again.

In addition, the hot topic pushing method provided in the embodiments of the present invention is not limited to use between user equipments that are used by users who perform the web chat. For example, when two users use mobile phones to perform short message service (SMS) chatting, processing may also be performed by using the hot topic pushing method provided in the embodiments of the present invention, whose principle and specific implementation process are similar to those in the foregoing embodiments and details are not described herein again.

FIG. 8 is a schematic structural diagram of Embodiment 1 of a hot topic pushing apparatus according to an embodiment of the present invention. As shown in FIG. 8, the hot topic pushing apparatus in this embodiment includes a receiving module 81 configured to receive a hot topic keyword, where the hot topic keyword is related to a second user; and a pushing module 82 configured to push a first message to a first user who uses the first user equipment, where the first message includes the hot topic keyword, or hot information related to the hot topic keyword, or both the hot topic keyword and hot information related to the hot topic keyword, which are available for the first user to select and use as a topic to communicate with the second user.

The hot topic pushing apparatus in this embodiment is used to execute the technical solution in the method embodiment shown in FIG. 1, and implementation principles and technical effects of the apparatus and the method are similar and details are not described herein again.

Further, the receiving module 81 is configured to receive the hot topic keyword by using a cloud server; or receive the hot topic keyword sent by a second user equipment that is used by the second user.

FIG. 9 is a schematic structural diagram of Embodiment 2 of a hot topic pushing apparatus according to an embodiment of the present invention. As shown in FIG. 9, on the basis of FIG. 8, the hot topic pushing apparatus in this embodiment further includes a processing module 83 configured to, if the first message includes the hot information, before the pushing module 82 pushes the first message to the first user, obtain the hot information according to the hot topic keyword, where the hot information includes information whose search volume or browsing volume exceeds a preset threshold, where the information is in a network and is related to the hot topic keyword.

Further, the processing module 83 is configured to obtain source information of the first message according to the hot topic keyword; and the pushing module 82 is configured to push the source information of the first message to the first user.

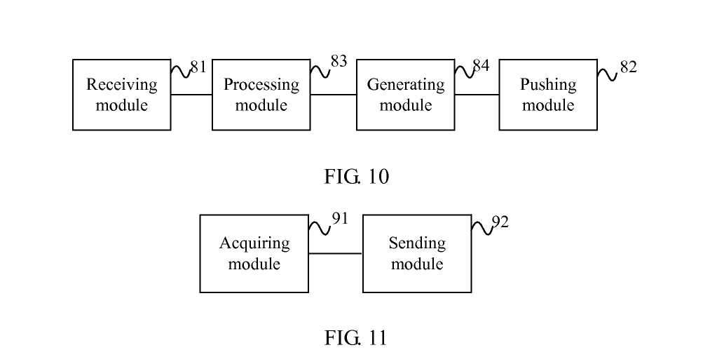

FIG. 10 is a schematic structural diagram of Embodiment 3 of a hot topic pushing apparatus according to an embodiment of the present invention. As shown in FIG. 10, on the basis of FIG. 9, the hot topic pushing apparatus in this embodiment further includes a generating module 84 configured to generate a hot topic pushing icon in a communication interface between the first user and the second user; where the pushing module 82 is configured to push the first message to the first user by using the hot topic pushing icon in the communication interface between the first user and the second user.

Further, the pushing module 82 is configured to, when the first user clicks or taps the hot topic pushing icon or the first user shakes the first user equipment, push at least one first message to the first user by using the hot topic pushing icon.

Further, the generating module 84 is configured to, when the first user clicks or taps the hot topic pushing icon or the first user shakes the first user equipment, generate at least one hot topic label, where each hot topic label includes one first message; and the pushing module 82 is configured to present the at least one hot topic label to the first user in the communication interface in a preset presenting manner.

Further, the pushing module 82 is configured to, when the first user clicks or taps the hot topic pushing icon and drags and shakes the hot topic pushing icon, present the at least one hot topic label to the first user in the communication interface in a manner of dropping from the hot topic pushing icon; or when the first user shakes the first user equipment, present the at least one hot topic label to the first user in the communication interface in a manner of dropping from the hot topic pushing icon.

Further, in the embodiment shown in FIG. 10, a higher speed or a longer time at which or during which the first user drags and shakes the hot topic pushing icon indicates more hot topic labels dropping from the hot topic pushing icon; or a higher speed or a longer time at which or during which the first user shakes the first user equipment indicates more hot topic labels dropping from the hot topic pushing icon.

Further, in the embodiment shown in FIG. 8 to FIG. 10, the hot topic keyword of the second user includes at least one of the following: a keyword in a chat record between the first user and the second user, a keyword in dynamic information published by the second user, and a keyword in a microblog published by the second user.

FIG. 11 is a schematic structural diagram of Embodiment 4 of a hot topic pushing apparatus according to an embodiment of the present invention. As shown in FIG. 11, the hot topic pushing apparatus in this embodiment includes an acquiring module 91 configured to acquire a hot topic keyword of a second user who uses a second user equipment; and a sending module 92 configured to send the hot topic keyword to a first user equipment, so that a first user who uses the first user equipment uses a first message as a topic to communicate with the second user, where the first message includes the hot topic keyword, or hot information related to the hot topic keyword, or both the hot topic keyword and hot information related to the hot topic keyword.

The hot topic pushing apparatus in this embodiment is used to execute the technical solution in the method embodiment shown in FIG. 6, and implementation principles and technical effects of the apparatus and the method are similar and details are not described herein again.

Further, the sending module 92 is configured to send the hot topic keyword to the first user equipment by using a cloud server; or directly send the hot topic keyword to the first user equipment.

Further, in the embodiment shown in FIG. 11, the hot topic keyword of the second user includes at least one of the following: a keyword in a chat record between the first user and the second user, a keyword in dynamic information published by the second user, and a keyword in a microblog published by the second user.

Further, the acquiring module 91 is configured to analyze at least one of the following: the chat record between the first user and the second user, the keyword in the dynamic information published by the second user, and the keyword in the microblog published by the second user, so as to acquire the hot topic keyword.

Persons of ordinary skill in the art may understand that all or some of the steps of the method embodiments may be implemented by a program instructing relevant hardware. The foregoing program may be stored in a computer-readable storage medium. When the program runs, the steps of the method embodiments are performed. The foregoing storage medium includes any medium that can store program code, such as a read-only memory (ROM), a random-access memory (RAM), a magnetic disk, or an optical disc.

Finally, it should be noted that the foregoing embodiments are merely intended for describing the technical solutions of the present invention, but not for limiting the present invention. Although the present invention is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of the embodiments of the present invention.

1. A hot topic pushing method, comprising:
receiving, by a first user equipment, a hot topic keyword, wherein the hot topic keyword is related to a second user; and
pushing, by the first user equipment, a first message to a first user who uses the first user equipment, wherein the first message comprises the hot topic keyword, hot information related to the hot topic keyword, or both the hot topic keyword and the hot information related to the hot topic keyword, which are available for the first user to select as a topic to communicate with the second user.

2. The method according to claim 1, wherein the receiving, by the first user equipment, the hot topic keyword comprises:
receiving, by the first user equipment, the hot topic keyword by using a cloud server; or
receiving, by the first user equipment, the hot topic keyword sent by a second user equipment that is used by the second user.

3. The method according to claim 1, wherein, when the first message comprises the hot information, before pushing, by the first user equipment, the first message to the first user who uses the first user equipment, the method further comprises obtaining, by the first user equipment, the hot information according to the hot topic keyword, wherein the hot information comprises information whose search volume or browsing volume exceeds a preset threshold, wherein the information is on an Internet and is related to the hot topic keyword.

4. The method according to claim 1, wherein, before pushing, by the first user equipment, the first message to the first user who uses the first user equipment, the method further comprises:
obtaining, by the first user equipment, source information of the first message according to the hot topic keyword; and
pushing, by the first user equipment, the source information of the first message to the first user.

5. The method according to claim 1, wherein pushing, by the first user equipment, the first message to the first user who uses the first user equipment comprises:
generating, by the first user equipment, a hot topic pushing icon in a communication interface between the first user and the second user; and
pushing, by the first user equipment, the first message to the first user by using the hot topic pushing icon in the communication interface between the first user and the second user.

6. The method according to claim 5, wherein pushing, by the first user equipment, the first message to the first user by using the hot topic pushing icon in the communication interface between the first user and the second user comprises: pushing, by the first user equipment by using the hot topic pushing icon, at least one first message to the first user when the first user clicks or taps the hot topic pushing icon or the first user shakes the first user equipment.

7. The method according to claim 6, wherein pushing, by the first user equipment by using the hot topic pushing icon, the at least one first message to the first user when the first user clicks or taps the hot topic pushing icon or the first user shakes the first user equipment comprises:
when the first user clicks or taps the hot topic pushing icon or the first user shakes the first user equipment, generating, by the first user equipment, at least one hot topic label, wherein each hot topic label comprises one first message; and
presenting, by the first user equipment, the at least one hot topic label to the first user in the communication interface in a preset presenting manner.

8. The method according to claim 7, wherein presenting, by the first user equipment, the at least one hot topic label to the first user in the communication interface in the preset presenting manner comprises:
when the first user clicks or taps the hot topic pushing icon and drags and shakes the hot topic pushing icon, presenting, by the first user equipment, the at least one hot topic label to the first user in the communication interface in a manner of dropping from the hot topic pushing icon; or
when the first user shakes the first user equipment, presenting, by the first user equipment, the at least one hot topic label to the first user in the communication interface in a manner of dropping from the hot topic pushing icon.

9. The method according to claim 8, wherein a higher speed or a longer time at which or during which the first user drags and shakes the hot topic pushing icon indicates more hot topic labels dropping from the hot topic pushing icon, or wherein the higher speed or the longer time at which or during which the first user shakes the first user equipment indicates more hot topic labels dropping from the hot topic pushing icon.

10. The method according to claim 1, wherein the hot topic keyword of the second user comprises at least one of the following: a keyword in a chat record between the first user and the second user, a keyword in dynamic information published by the second user, and a keyword in a microblog published by the second user.

11. A hot topic pushing method, comprising:
acquiring, by a second user equipment-UE, a hot topic keyword of a second user who uses the second user equipment; and
sending, by the second user equipment, the hot topic keyword to a first user equipment such that a first user who uses the first user equipment uses a first message as a topic to communicate with the second user, wherein the first message comprises the hot topic keyword, hot information related to the hot topic keyword, or both the hot topic keyword and the hot information related to the hot topic keyword.

12. The method according to claim 11, wherein sending, by the second user equipment, the hot topic keyword of the second user to the first user equipment comprises:
sending, by the second user equipment, the hot topic keyword to the first user equipment by using a cloud server; or
directly sending, by the second user equipment, the hot topic keyword to the first user equipment.

13. The method according to claim 11, wherein the hot topic keyword of the second user comprises at least one of the following: a keyword in a chat record between the first user and the second user, a keyword in dynamic information published by the second user, and a keyword in a microblog published by the second user.

14. The method according to claim 13, wherein acquiring, by the second user equipment, the hot topic keyword of the second user who uses the second user equipment comprises: analyzing, by the second user equipment, at least one of the following: the keyword in a historical chat record between the first user and the second user, the keyword in dynamic information published by the second user, and the keyword in the microblog published by the second user, to acquire the hot topic keyword.

15. A hot topic pushing apparatus, disposed on a first user equipment, comprising:
a receiving module configured to receive a hot topic keyword, wherein the hot topic keyword is related to a second user; and
a pushing module configured to push a first message to a first user who uses the first user equipment, wherein the first message comprises the hot topic keyword, hot information related to the hot topic keyword, or both the hot topic keyword and the hot information related to the hot topic keyword, which are available for the first user to select and use as a topic to communicate with the second user.

16. The hot topic pushing apparatus according to claim 15, wherein the receiving module is configured to:
receive the hot topic keyword by using a cloud server; or
receive the hot topic keyword sent by a second user equipment that is used by the second user.

17. The hot topic pushing apparatus according to claim 15, further comprising: a processing module configured to, when the first message comprises the hot information, before the pushing module pushes the first message to the first user, obtain the hot information according to the hot topic keyword, wherein the hot information comprises information whose search volume or browsing volume exceeds a preset threshold, and wherein the information is in a network and is related to the hot topic keyword.

18. The hot topic pushing apparatus according to claim 15, wherein the processing module is further configured to obtain source information of the first message according to the hot topic keyword, and wherein the pushing module is further configured to push the source information of the first message to the first user.

19. The hot topic pushing apparatus according to claim 15, further comprising: a generating module configured to generate a hot topic pushing icon in a communication interface between the first user and the second user, and wherein the pushing module is configured to push the first message to the first user by using the hot topic pushing icon in the communication interface between the first user and the second user.

20. The hot topic pushing apparatus according to claim 19, wherein the pushing module is configured when the first user clicks or taps the hot topic pushing icon or the first user shakes the first user equipment, push at least one first message to the first user by using the hot topic pushing icon.

21. The hot topic pushing apparatus according to claim 20, wherein the generating module is further configured to when the first user clicks or taps the hot topic pushing icon or the first user shakes the first user equipment, generate at least one hot topic label, wherein each hot topic label comprises one first message and wherein the pushing module is further configured to present the at least one hot topic label to the first user in the communication interface in a preset presenting manner.

22. The hot topic pushing apparatus according to claim 21, wherein the pushing module is configured to:
when the first user clicks or taps the hot topic pushing icon and drags and shakes the hot topic pushing icon, present the at least one hot topic label to the first user in the communication interface in a manner of dropping from the hot topic pushing icon; or
when the first user shakes the first user equipment, present the at least one hot topic label to the first user in the communication interface in a manner of dropping from the hot topic pushing icon.

23. The hot topic pushing apparatus according to claim 22, wherein a higher speed or a longer time at which or during which the first user drags and shakes the hot topic pushing icon indicates more hot topic labels dropping from the hot topic pushing icon, or wherein the higher speed or the longer time at which or during which the first user shakes the first user equipment indicates more hot topic labels dropping from the hot topic pushing icon.

24. The hot topic pushing apparatus according to claim 15, wherein the hot topic keyword of the second user comprises at least one of the following: a keyword in a chat record between the first user and the second user, a keyword in dynamic information published by the second user, and a keyword in a microblog published by the second user.

25. A hot topic pushing apparatus, disposed on a second user equipment, comprising:
an acquiring module; configured to acquire a hot topic keyword of a second user who uses the second user equipment; and
a sending module configured to send the hot topic keyword to a first user equipment such that a first user who uses the first user equipment uses a first message as a topic to communicate with the second user, wherein the first message comprises the hot topic keyword, hot information related to the hot topic keyword, or both the hot topic keyword and the hot information related to the hot topic keyword.

26. The hot topic pushing apparatus according to claim 25, wherein the sending module is configured to:
send the hot topic keyword to the first user equipment by using a cloud server; or
directly send the hot topic keyword to the first user equipment.

27. The hot topic pushing apparatus according to claim 25, wherein the hot topic keyword of the second user comprises at least one of the following: a keyword in a chat record between the first user and the second user, a keyword in dynamic information published by the second user, and a keyword in a microblog published by the second user.

28. The hot topic pushing apparatus according to claim 27, wherein the acquiring module is configured to analyze at least one of the following: a chat record between the first user and the second user, the keyword in dynamic information published by the second user, and the keyword in the microblog published by the second user, to acquire the hot topic keyword.
